(19) United States
(12) Patent Application Publication
(10) Pub. No.: US 2006/0204197 A1
(43) Pub. Date: Sep. 14, 2006

(54) Optical waveguide and method for preparing the same

(76) Inventors: Nobuo Miyadera, Tsukuba-shi (JP); Rei Yamamoto, Tsukuba-shi (JP); Tooru Takahashi, Tsukuba-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/417,041

(22) Filed: May 4, 2006

Related U.S. Application Data
(63) Continuation of application No. PCT/JP04/16790, filed on Nov. 5, 2004.

(30) Foreign Application Priority Data
Nov. 5, 2003 (JP) 2003-376024

(51) Int. Cl. G02B 6/10

(52) U.S. Cl. 385/129

(57) ABSTRACT

The present invention herein provides an optical waveguide which comprises a cladding and a core formed on a substrate, wherein a refractive index of a material constituting the cladding on the upper side of the core is smaller than a refractive index of a material constituting the cladding on the lateral side of the core and a refractive index of a material constituting the cladding on the lower side of the core; an optical waveguide (an optical waveguide for coupling) which is used for coupling with an optical waveguide (an optical waveguide to be coupled) having a refractive index distribution within a core in the vertical direction, wherein a cladding has a refractive index distribution in the vertical direction; and a method for the preparation thereof. The optical waveguide of the present invention permits the reduction of the coupling loss observed when it is coupled with an optical waveguide whose core is formed by the diffusion technique such as a lithium niobate optical waveguide.

### TECHNICAL FIELD

The present invention relates to an optical waveguide and a method for the preparation thereof and, in particular, an optical waveguide useful for coupling, at a low coupling loss, with an optical waveguide (a multi-coupling optical waveguide) which is prepared by the diffusion or ion-exchange technique and whose refractive index has a distribution along the direction perpendicular to the surface thereof as well as a method for the production thereof.

### BACKGROUND ART

There has rapidly been increased the demand for information transmission along with the recent wide spread of personal computers and the internet. For this reason, it has been desired to spread the optical transmission system having a high transmission rate even to terminal information-processing units such as personal computers. The realization thereof would certainly require the production of high quality optical waveguides used for the optical inter-connection, in large quantities and at a reasonable price.

As materials for the optical waveguide, there have been known, for instance, lithium niobate (LiNbO₃) as a dielectric crystalline material in addition to glass materials, semiconductor materials and resins. This lithium niobate possesses an electro-optic effect which permits the control of a refractive index of light waves by the application of an external electric field and therefore, it has been used as an optical modulator in the optical communication system. As methods for the production of an optical waveguide using lithium niobate, there have been known, for instance, those comprising the steps of forming a core pattern on the surface of a lithium niobate substrate with, for instance, Ti and then making the Ti diffuse from the surface to the inside of the substrate to thus form a region having a high refractive index, but the optical waveguide whose core is formed according to such a diffusion technique has such a cross-sectional structure as shown in FIG. 8. More specifically, the cross-sectional structure of the core is not symmetric in the direction along the depth of the substrate (or the direction perpendicular to the substrate) and thus has a refractive index distribution.

Moreover, the core pattern is approximately semicircle in case of the glass optical waveguide produced by the ion-exchange technique. The optical waveguide produced by the ion-exchange technique is disclosed in, for instance, an article of SUGAWARA et al. (Thesis No. 369, Showa 62 (1987)) reported in National Meeting of the Semiconductor•Material Group in The Japan Society of Electronic Information and Communication Research. More specifically, the ion-exchange technique comprises the steps of covering the surface of a glass substrate with a masking film for inhibiting any ion-penetration, forming, in advance, an opening having a desired pattern of an optical waveguide and bringing the glass substrate covered with the masking film into close contact with a molten salt containing cations which can increase a refractive index of the glass to make the ions present in the salt diffuse into the glass and to thus replace ions present in the glass with those present in the salt. Thus, a high refractive index region is formed, which has such a refractive index distribution that it is gradually reduced from the portion corresponding to the opening of the masking film toward the interior of the glass substrate and which has an approximately semicircular cross-section. In other words, the optical waveguide produced by the ion-exchange technique likewise has a refractive index distribution in the cross-section of the core in the direction along the depth of the substrate (or the direction perpendicular to the substrate).

Alternatively, an optical waveguide can likewise be produced by the so-called photo-bleaching technique which comprises the step of irradiating, with ultraviolet rays, a substrate formed from a material sensitive to, for instance, ultraviolet rays in a desired core pattern or through a negative pattern thereof to induce a refractive index change in a desired region and to thus form a high refractive index region. However, the optical waveguide produced by this technique does not always show any distinct boundary between the high refractive index and low refractive index regions depending on, for instance, the transmittance of ultraviolet rays, the reaction rate induced by the irradiation with ultraviolet rays and the diffusion in the reaction sites and the cross-sectional structure of the core is not completely symmetric in the direction along the depth of the substrate. In other words, the cross-sectional structure of the core has a refractive index distribution in the direction along the depth of the substrate (or the direction perpendicular to the substrate) even in such an optical waveguide.

Moreover, there has also been known an optical waveguide produced by using a plurality of monomer materials having high sensitivity to, for instance, ultraviolet rays, irradiating, with ultraviolet rays, a coated film of the foregoing monomer materials to induce the diffusion of the monomers and to thus form high refractive index and low refractive index regions, while making use of the fact that the cured products of the foregoing plurality of monomers have different refractive indexes and that these monomers are different in sensitivities to ultraviolet rays. The cross-sectional structure of the core of the optical waveguide produced by this technique is not symmetric in the direction along the depth of the substrate. In other words, the cross-sectional structure of the core has a refractive index distribution in the direction along the depth of the substrate (or the direction perpendicular to the substrate) even in such an optical waveguide.

On the other hand, resins have long been known as materials for optical waveguides and when core and cladding layers of an optical waveguide are formed from, for instance, a polyimide having a high glass transition point (Tg) and high heat resistance, the resulting optical waveguide would have good reliability over a long period of time and can withstand even the soldering operations.

Such a polymeric optical waveguide can be prepared by, for instance, forming a cladding layer on a substrate such as a silicon substrate, etching the cladding layer to form a core pattern, applying a resin coating for forming a core onto the cladding layer to thus form a core layer and then forming a cladding layer on the core thus formed using the same material used for forming the lateral and lower cladding layers (see FIG. 9).

When coupling the conventional optical waveguide thus prepared with the optical waveguide produced by the diffusion method such as the foregoing optical waveguide made of lithium niobate and then practically using the resulting assembly, a problem arises such that the coupling loss is high on the order of 1 dB, but there has not conventionally been known any optical waveguide intended to couple with and use in combination with such an optical waveguide whose core is formed by the diffusion technique.

On the other hand, there has been reported such an optical waveguide in which a refractive index of the cladding layer on the sides of the core is increased as compared with that of the cladding layer on the top and the bottom of the core for the purpose of preventing any transmission loss depending on the polarized directions of light waves (see Patent Document 1 specified below). In this example, it is proposed that an optical waveguide is designed so as to have a difference in the refractive index between the portions of the cladding layer on the vertical and horizontal directions with respect to the substrate within the cross-section of the core or so as to have a difference in the strength for confining light waves within the core and that any anisotropy in the transmission loss between the polarized waves horizontal with and perpendicular to the substrate can thus be reduced. However, the optical waveguide of this prior art is developed for the achievement of a desired effect, while mainly taking notice of the properties of the light waves transmitting through the waveguide, the coupling loss thereof investigated therein is simply that originated from the coupling with a single mode fiber and the prior art neither refers to the coupling of the waveguide with other optical waveguides nor suggests any measure to solve the problem concerning the same.

Moreover, there has also been developed a technique which comprises the steps of forming different optical waveguide portions or an optical waveguide portion produced by the titanium diffusion technique and an optical waveguide portion produced by the proton-exchange technique on a lithium niobate substrate to thus form an optical waveguide comprising monolithically connected different optical waveguide portions (see Patent Document 2 specified below). This prior art is developed mainly aiming at the reduction of the transmission loss, it never deals with the matching of the mode-field shape (the reduction of mode coupling or mode transformation losses) and it does not suggest any measure to solve the problem related thereto.

Further, there has likewise been proposed a technique for arranging a refractive index-conditioning region (AR coat and adhesive regions) when connecting a quartz optical waveguide to a lithium niobate optical waveguide (see Patent Document 3 specified below). In general, a refractive index of the quartz optical waveguide differs from that of the lithium niobate optical waveguide and therefore, the reflection of the light waves transmitted through the same are reflected at the boundary between these two connected waveguides. It is an object of the invention disclosed in the document to reduce the loss (Fresnel's loss) due to such reflection, it does not deal with the coupling loss originated from the matching of the mode-field shape and it does not suggest any measure to solve the problem related thereto.

Furthermore, Japanese Un-Examined Patent Publication (hereafter simply referred to as “JP-A”) Hei 09-043442 and JP-A 2001-004857 as prior arts disclose techniques for reducing the coupling loss observed when connecting such a lithium niobate optical waveguide with an optical fiber, in which the diffusion process used in the production of the lithium niobate optical waveguide is divided into two sub-steps. As has been described above, the transmission loss observed when coupling an optical fiber or an optical waveguide with a lithium niobate optical waveguide can be reduced by the modification of the mode-field shape of the lithium niobate optical waveguide, but this technique suffers from a problem in that a complicated process is required for the production of the same and this in turn leads to an increase in the production cost.

Patent Document 1: JP-A Hei 11-133254

Patent Document 2: JP-A Hei 05-072430

Patent Document 3: JP-A Hei 07-020413

### DISCLOSURE OF THE INVENTION

It is an object of the present invention to provide an optical waveguide which can realize a confinement structure asymmetric with respect to the vertical direction, and which permits the good coupling with an optical waveguide such as one produced by the diffusion technique (hereafter referred to as diffusion (optical) waveguide) having a mode-field shape asymmetric with respect to the vertical direction, and to provide a method for the production of the same.

It is another object of the present invention to provide an optical waveguide which can be coupled with, at a low coupling loss, a diffusion optical waveguide or an optical waveguide produced by the ion-exchange technique (hereafter referred to as ion-exchange (optical) waveguide) such as lithium niobate optical waveguide, in which the cross-sectional pattern of the core thereof is not symmetric in the direction along the depth of the substrate thereof and to provide a method for the production of the same.

The present invention has been completed as a result of the various studies on the construction of an optical waveguide having a low coupling loss while taking into consideration the fact that the difference in the mode-field shape would be a primary factor of the coupling loss observed when connected with an optical waveguide having a refractive index distribution in the cross-section of the core in the direction along the depth of the substrate (or the direction perpendicular to the substrate).

In the present invention, the cross-sectional shape of the cladding is so designed that it can most suitably be coupled with the mode-field shape (for instance, the way how the mode spreads, and the asymmetric characteristics) of a core of, for instance, a diffusion optical waveguide as a subject. In other word, the present invention solves the foregoing problem or the present invention provides an optical waveguide (hereafter also referred to as “an optical waveguide for coupling”), which can be coupled with, at a low coupling loss, an optical waveguide having a refractive index distribution in the cross-section of the core in the direction along the depth of the substrate (or the direction perpendicular to the substrate) (hereafter also referred to as “an optical waveguide to be coupled”) and which comprises a cladding having a refractive index distribution, preferably a cladding having a refractive index distribution in the direction along the depth of the substrate (or the direction perpendicular to the substrate), wherein the refractive index distribution of the optical waveguide for coupling is opposite to that observed for the core of the optical waveguide to be coupled. In addition, the present invention solves the foregoing problems by establishing a desired relation between the relative magnitude of the refractive indexes of the upper and lower claddings of the optical waveguide for coupling which is completely opposite to the refractive index distribution with respect to the direction perpendicular to the core observed for the optical waveguide to be coupled.

In a preferred embodiment of the present invention, there is provided an optical waveguide having a rectangular cross section, which can be coupled with a diffusion optical waveguide at a low coupling loss, even if the diffusion optical waveguide to be coupled is one produced by the usual production method.

The term “diffusion optical waveguide” used herein means an optical waveguide which has a core prepared by such a method as “diffusion method”, “ion-exchange method”, “photo-bleaching method”, or “monomer-diffusion method” and whose core has a refractive index distribution in the direction along the depth of the substrate (or the direction perpendicular to the substrate).

The term “coupling” used herein means that an optical waveguide for coupling and an optical waveguide to be coupled are connected together in such a manner that light waves can pass through these optical waveguides. In this respect, the optical waveguide for coupling and the optical waveguide to be coupled may be brought into close contact with one another or they may be kept apart from one another or they may likewise be adhered to one another through a different substance lying between them, for instance, an adhesive layer, a layer of a refractive index-controlling agent, a filter and/or an anti-reflection film. Alternatively, they may likewise be coupled through the space-coupling.

The following are optical waveguides and methods for the production thereof according to the present invention:

1. An optical waveguide which comprises a cladding and a core formed on a substrate, wherein a refractive index n1 of a material constituting the cladding on the upper side of the core is smaller than a refractive index n2 of a material constituting the cladding on the lateral side of the core and a refractive index n3 of a material constituting the cladding on the lower side of the core.

2. The optical waveguide as set forth in the foregoing item 1, wherein the refractive index n1 of the material constituting the cladding on the upper side of the core, the refractive index n2 of the material constituting the cladding on the lateral side of the core and the refractive index n3 of the material constituting the cladding on the lower side of the core satisfy the following relation: n1≦nx×0.974 (provided that nx represents a smaller value selected from n2 and n3).

3. The optical waveguide as set forth in the foregoing item 1 or 2, wherein each of the core material and the materials constituting the cladding on the lateral side of the core and the cladding on the lower side of the core is selected from the group consisting of polyimide resins, acrylic resins, epoxy resins, phenolic resins, silicone resins, and fluorocarbon resins.

4. The optical waveguide as set forth in the foregoing item 1 or 2, wherein the materials constituting at least two portions selected from the core, the cladding on the upper side of the core, the cladding on the lateral side of the core and the cladding on the lower side of the core are different two materials selected from the group consisting of air, SiO₂, acrylic resins, polyimide resins, epoxy resins, phenolic resins, silicone resins, and fluorocarbon resins.

5. The optical waveguide as set forth in any one of the foregoing items 1 to 4, wherein the material constituting the cladding on the upper side of the core is a member selected from the group consisting of air, SiO₂, acrylic resins, polyimide resins, epoxy resins, phenolic resins, silicone resins, and fluorocarbon resins.

6. The optical waveguide as set forth in any one of the foregoing items 1 to 5, wherein the material constituting the cladding on the upper side of the core is a member selected from the group consisting of air, SiO₂ and acrylic resins.

7. The optical waveguide as set forth in any one of the foregoing items 3 to 6, wherein the polyimide resin is a fluorinated polyimide resin.

8. A method for producing an optical waveguide whose upper side of the core is exposed, comprising the following steps:

a first step for forming a lower cladding on a substrate and then further forming a core layer on the lower cladding;

a second step for patterning the core layer in the form of an optical waveguide to thus form a core;

a third step for applying a lateral cladding-forming material onto the surface of the lower cladding and the side of the core till the upper surface of the core is completely covered with the material to thus form a lateral cladding; and

a fourth step for removing the lateral cladding-forming material which covers the upper side of the core till the upper surface of the core is exposed.

9. A method for producing an optical waveguide comprising the following steps:

a first step for forming a lower cladding on a substrate and then further forming a core layer on the lower cladding;

a second step for patterning the core layer in the form of an optical waveguide to thus form a core;

a third step for applying a lateral cladding-forming material onto the surface of the lower cladding and the side of the core till the upper surface of the core is completely covered with the material to thus form a lateral cladding;

a fourth step for removing the lateral cladding-forming material which covers the upper side of the core till the upper surface of the core is exposed; and

a fifth step for applying, onto the top surface of the exposed core, an upper cladding-forming material having a refractive index n1 smaller than a refractive index n2 of the lateral cladding-forming material and a refractive index n3 of the lower cladding-forming material to thus form an upper cladding on the core.

10. A method for producing an optical waveguide whose upper side of the core is exposed, comprising the following steps:

a first step for forming a cladding layer which ultimately serves as a cladding on the lateral side of the core and a cladding on the lower side of the core;

a second step for forming, in the cladding layer, a concaved portion for forming a core; and

a third step for filling the concaved portion for forming a core with a solution of a core-forming material and drying the same to form a core.

11. A method for producing an optical waveguide comprising the following steps:

a first step for forming a cladding layer which ultimately serves as a cladding on the lateral side of the core and a cladding on the lower side of the core;

a second step for forming, in the cladding layer, a concaved portion for forming a core;

a third step for filling the concaved portion for forming a core with a solution of a core-forming material and drying the same to form a core; and

a fourth step for applying, onto the top surface of the core, an upper cladding-forming material having a refractive index n 1 smaller than a refractive index n2 of the lateral cladding-forming material and a refractive index n3 of the lower cladding-forming material to thus form an upper cladding on the core.

12. The method as set forth in the foregoing item 9 or 11, wherein the refractive index n1 of the material constituting the cladding on the upper side of the core, the refractive index n2 of the material constituting the cladding on the lateral side of the core and the refractive index n3 of the material constituting the cladding on the lower part of the core satisfy the following relation: n1≦nx×0.974 (provided that nx represents a smaller value selected from n2 and n3).

13. The method as set forth in any one of the foregoing items 8 to 12, wherein each of the core material and the materials constituting the cladding on the lateral side of the core and the cladding on the lower side of the core is selected from the group consisting of polyimide resins, acrylic resins, epoxy resins, phenolic resins, silicone resins, and fluorocarbon resins.

14. The method as set forth in any one of the foregoing items 9, 11 to 13, wherein the material for forming the cladding on the upper side of the core is a member selected from the group consisting of air, SiO₂, acrylic resins, polyimide resins, epoxy resins, phenolic resins, silicone resins, and fluorocarbon resins

15. A method for producing an optical waveguide comprising a first step for forming a core layer on the surface of a glass substrate; a second step for patterning the core layer in the form of an optical waveguide to thus form a core; and a third step for applying a cladding-forming material onto the product of the second step till the upper surface of the core is completely covered with the material to thus form a cladding layer.

16. The method as set forth in the foregoing item 15, wherein a refractive index n5 of the cladding-forming material and a refractive index n4 of the glass substrate satisfy the following relation: n4≦n5×0.974.

17. The method as set forth in the foregoing item 15 or 16, wherein each of the core-forming material and the cladding-forming material is selected from the group consisting of polyimide resins, acrylic resins, epoxy resins, phenolic resins, silicone resins, and fluorocarbon resins.

18. The method as set forth in any one of the foregoing items 13, 14 and 17, wherein the polyimide resin is a fluorinated polyimide resin.

19. An optical waveguide (an optical waveguide for coupling) which is used for coupling with an optical waveguide (an optical waveguide to be coupled) having a refractive index distribution within the core in the vertical direction, wherein the cladding has a refractive index distribution in the vertical direction.

20. The optical waveguide for coupling as set forth in the foregoing item 19, wherein the refractive index distribution within the cladding is almost opposite to the refractive index distribution within the core of the optical waveguide to be coupled.

21. An optical waveguide (optical waveguide for coupling) which is used for coupling with an optical waveguide (an optical waveguide to be coupled) having a refractive index distribution within the core in the vertical direction, wherein the relation between the relative magnitude of the refractive indexes of the upper and lower cladding of the optical waveguide for coupling is completely opposite to the refractive index distribution in the vertical direction observed for the optical waveguide to be coupled.

22. The optical waveguide for coupling as set forth in any one of the foregoing items 19 to 21, wherein the optical waveguide to be coupled is a diffusion optical waveguide.

23. The optical waveguide for coupling as set forth in the foregoing item 22, wherein the diffusion optical waveguide is an optical waveguide whose core is one formed by allowing titanium to diffuse in a lithium niobate substrate.

### BRIEF DESCRIPTION OF THE DRAWINGS

FIG. 1 is a cross-sectional view schematically showing an optical waveguide according to the present invention.

FIG. 2 is a cross-sectional view schematically showing an embodiment of the optical waveguide according to the present invention.

FIG. 3 is a cross-sectional view schematically showing an embodiment of the optical waveguide according to the present invention.

FIG. 4 is a cross-sectional view schematically showing an embodiment of the optical waveguide according to the present invention.

FIGS. 5(1) to (9) are a series of cross-sectional views schematically showing an example of the process for the production of an optical waveguide according to the present invention.

FIGS. 6(1) to (7) are a series of cross-sectional views schematically showing an example of the process for the production of an optical waveguide according to the present invention.

FIGS. 7(1) to (4) are a series of cross-sectional views schematically showing an example of the process for the production of an optical waveguide according to the present invention.

FIG. 8 is a cross-sectional view schematically showing a lithium niobate optical waveguide.

FIG. 9 is a cross-sectional view schematically showing a conventional optical waveguide.

FIG. 10 shows a cross-sectional view of an optical waveguide to be coupled in which the refractive index of the cladding is continuously increased and a graph illustrating the refractive index distribution thereof.

FIG. 11 shows a cross-sectional view of an optical waveguide to be coupled in which the refractive index of the cladding is stepwise increased and a graph illustrating the refractive index distribution thereof.

FIG. 12 is a diagram showing the mode-field profile, in the vertical direction (in the direction along the depth), of an optical waveguide to be coupled used for the calculation of the coupling loss.

FIG. 13 is a diagram showing the mode-field profile, in the horizontal direction (in the direction along the width), of an optical waveguide to be coupled used for the calculation of the coupling loss.

FIG. 14 is a graph showing the calculated coupling loss values obtained when the core width of the optical waveguide is changed.

FIG. 15 is a graph showing the calculated coupling loss values obtained when the core thickness of the optical waveguide is changed.

### DESCRIPTION OF SYMBOLS

1 . . . Silicon Substrate;
3a . . . Lower Cladding;
3b . . . Lateral cladding;
4 . . . Core;
5 . . . Upper Cladding;
6, 7 . . . Mask;
8 . . . Concaved Portion;
9 . . . Core-Forming Material;
10 . . . Laminated Optical Waveguide;
11 . . . Glass Plate;
12 . . . Core;
13 . . . Cladding;
20 . . . SiO₂;
21 . . . LiNbO₃;
22 . . . Ti-Diffused Core;
30 . . . Cladding;
31 . . . Core;
40 . . . Core;
41, 42, 43, 44 . . . Cladding.

### BEST MODE FOR CARRYING OUT THE INVENTION

The present invention relates to an optical waveguide (an optical waveguide for coupling) which is used for coupling with an optical waveguide (an optical waveguide to be coupled) having a refractive index distribution within the core in the vertical direction, wherein the cladding has a refractive index distribution and preferably a refractive index distribution in the vertical direction of the cladding, which is almost opposite to the refractive index distribution within the core of the optical waveguide to be coupled. In this respect, the phrase “a refractive index distribution almost opposite to the refractive index distribution” means that the refractive index of the cladding of the optical waveguide for coupling is gradually reduced in the direction along which the refractive index of the optical waveguide to be coupled is gradually increased.

In addition, the present invention likewise relates to an optical waveguide for coupling in which the relation between the relative magnitude of the refractive indexes of the upper and lower claddings of the optical waveguide for coupling is completely opposite to that, in the vertical direction, observed for the optical waveguide to be coupled and, in other words, the invention relates to an optical waveguide for coupling wherein, when the refractive index of the core of the optical waveguide to be coupled is higher at the upper portion thereof as compared with that observed for the lower portion thereof, the refractive index of the upper cladding is smaller than that of the lower cladding.

As the optical waveguide to be coupled, there may be listed, for instance, diffusion optical waveguides or those having cores each prepared by a method such as “diffusion method”, “ion-exchange method”, “photo-bleaching method”, or “monomer-diffusion method” such as those comprising cores each formed by making titanium diffuse in a lithium niobate substrate.

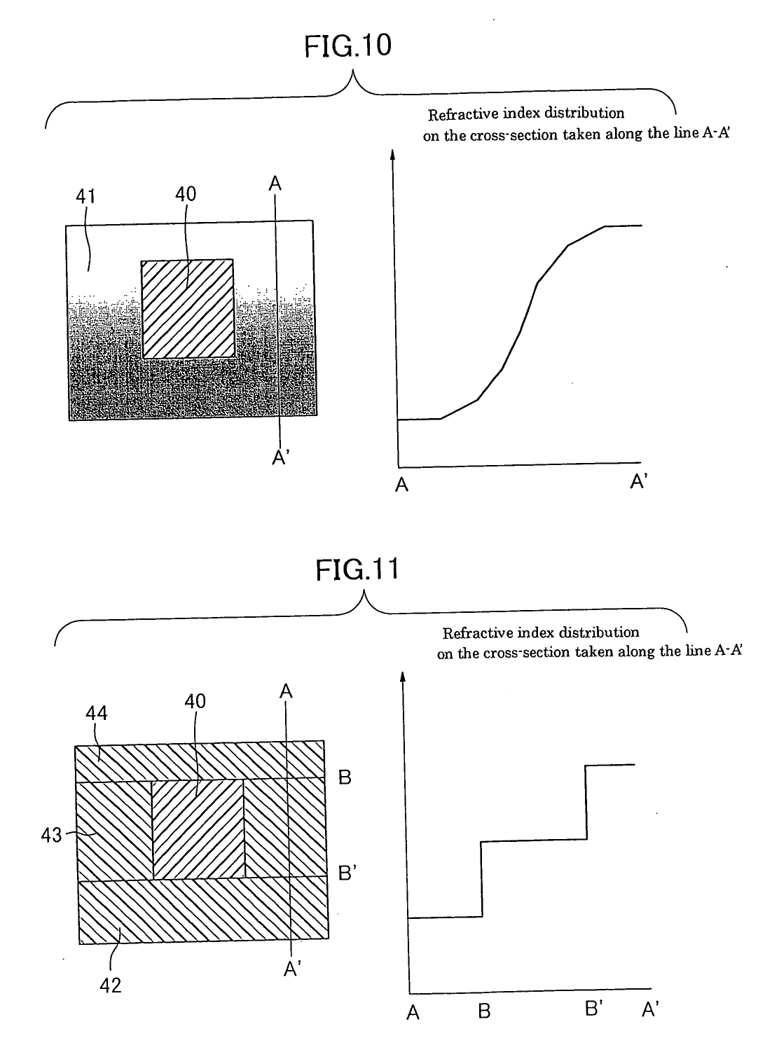

Specific examples of these optical waveguides for coupling include those each characterized in that it comprises a cladding and a core formed on a substrate and that a refractive index n1 of a material constituting the cladding on the upper side of the core is smaller than a refractive index n2 of a material constituting the cladding on the lateral side of the core and a refractive index n3 of a material constituting the cladding on the lower side of the core. In this respect, FIG. 10 shows a cross-sectional view of an optical waveguide to be coupled in which a refractive index of the cladding is continuously increased and a graph illustrating the refractive index distribution thereof and FIG. 11 shows a cross-sectional view of an optical waveguide to be coupled in which the refractive index of the cladding is stepwise increased and a graph illustrating the refractive index distribution thereof.

The optical waveguide for coupling according to the present invention suitably used for coupling with such an optical waveguide to be coupled as shown in FIG. 11 can be prepared according to the following method:

A method for producing an optical waveguide whose upper side of the core is exposed, comprises the following steps: a first step for forming a lower cladding on a substrate and then further forming a core layer on the lower cladding; a second step for patterning the core layer in the form of an optical waveguide to thus form a core; a third step for applying a lateral cladding-forming material onto the surface of the lower cladding and the side of the core till the upper surface of the core is completely covered with the material to thus form a lateral cladding; and a fourth step for removing the lateral cladding-forming material which covers the upper side of the core till the upper surface of the core is exposed, or

A method for producing an optical waveguide comprises the following steps: a first step for forming a lower cladding on a substrate and then further forming a core layer on the lower cladding; a second step for patterning the core layer in the form of an optical waveguide to thus form a core; a third step for applying a lateral cladding-forming material onto the surface of the lower cladding and the side of the core till the upper surface of the core is completely covered with the material to thus form a lateral cladding; a fourth step for removing the lateral cladding-forming material which covers the upper side of the core till the upper surface of the core is exposed; and a fifth step for applying, onto the top surface of the exposed core, an upper cladding-forming material having a refractive index n1 smaller than a refractive index n2 of the lateral cladding-forming material and a refractive index n3 of the lower cladding-forming material to thus form an upper cladding on the core.

The foregoing fourth step may be carried out by, for instance, the etching technique. This etching technique is advantageous in that it can highly precisely expose the top surface of the core. Alternatively, the fourth step may likewise be carried out by removing the cladding-forming material covering the top of the core through a mechanical technique such as the polishing technique. This mechanical technique has such an advantage that it can make, flat, the surface of the core and the lateral cladding.

The foregoing optical waveguide can likewise be produced according to the following method:

A method for producing an optical waveguide whose upper side of the core is exposed, comprises the following steps: a first step for forming a cladding layer which ultimately serves as a cladding on the lateral side of the core and a cladding on the lower side of the core; a second step for forming, in the cladding layer, a concaved portion for forming a core; and a third step for filling the concaved portion for forming a core with a solution of a core-forming material and drying the same to form a core, or A method for producing an optical waveguide comprises the following steps: a first step for forming a cladding layer which ultimately serves as a cladding on the lateral side of the core and a cladding on the lower side of the core; a second step for forming, in the cladding layer, a concaved portion for forming a core; a third step for filling the concaved portion for forming a core with a solution of a core-forming material and drying the same to form a core; and a fourth step for applying, onto the top surface of the core, an upper cladding-forming material having a refractive index n1 smaller than a refractive index n2 of the lateral cladding-forming material and a refractive index n3 of the lower cladding-forming material to thus form an upper cladding on the core.

The foregoing second step may be carried out by, for instance, the etching technique. This etching technique is advantageous in that the technique can form a core having a highly precise shape and that it can further improve the precision of the relative alignment of the core pattern thus formed with other structures formed on the optical waveguide such as a V-shaped groove, electrodes, and a mark for alignment.

Alternatively, this second step may likewise be carried out by the embossing technique. This technique is advantageous in that the production cost of the optical waveguide can be reduced in case of the mass-production. In addition, this embossing technique would permit the elimination of the first step when using, as the substrate, a material which can also serve as the lower and lateral cladding of the ultimate optical waveguide.

The foregoing optical waveguide can likewise be produced according to the following method:

A method for producing an optical waveguide comprises a first step for forming a core layer on the surface of a glass substrate; a second step for patterning the core layer in the form of an optical waveguide to thus form a core; and a third step for applying a cladding-forming material onto the product of the second step till the upper surface of the core is completely covered with the material to thus form a cladding layer.

In this case, the substrate serves as the upper cladding and the cladding layer formed in the third step constitutes the lateral cladding and the lower cladding. In other words, the optical waveguide is prepared, in this case, while turning the waveguide upside down. The glass plate may be replaced with a substrate provided thereon with a layer of a material capable of serving as the upper cladding. Such a substrate may be, for instance, one comprising a silicone substrate and an SiO₂ layer applied onto the surface thereof. In this case, the upper side of the core and the upper side of the lateral cladding are formed on the glass plate and accordingly, a flat boundary can easily be formed. Moreover, the number of steps required for the production thereof may be reduced and therefore, this results in the saving of the production cost.

The optical waveguide and the method for preparing the same according to the present invention permit the reduction of the coupling loss encountered when coupling the waveguide of the invention with an optical waveguide whose core is prepared according to the diffusion technique, such as a lithium niobate optical waveguide and thus permit the realization of highly efficient coupling.

[Optical Waveguide]

The optical waveguide of the present invention will now be described in detail below.

The optical waveguide (optical waveguide for coupling) according to the present invention is developed in order to reduce the coupling loss encountered when coupling the waveguide of the invention with an optical waveguide whose core is prepared by the diffusion technique, such as a lithium niobate optical waveguide.

As has been discussed above, the optical waveguide whose core is prepared by the diffusion technique may be, for instance, one obtained by diffusing Ti or the like into lithium niobate; a glass optical waveguide produced using the ion-exchange technique; and one prepared using a resin.

The present invention will be described in detail while taking an optical waveguide prepared using lithium niobate (LiNbO₃) as a dielectric crystalline material by way of example, but the present invention is not restricted to such a specific example at all.

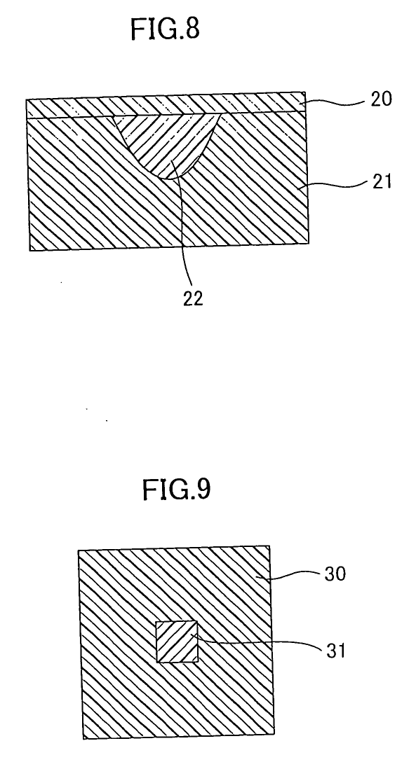

Lithium niobate possesses an electro-optic effect which permits the control of a refractive index of light waves by the application of an external electric voltage and for this reason, it has been used as an optical modulator in the optical communication system. As methods for preparing an optical waveguide using this lithium niobate, there have been known, for instance, the etching, titanium-diffusion and proton-exchange techniques and, in particular, the cross-sectional structure of an optical waveguide whose core is formed by the thermal diffusion technique has such a construction that the core is embedded in the cladding as shown in FIG. 8. In addition, an SiO₂ layer having a thickness ranging from about 1 to 2 μm is in general present on the upper sides of the core and the cladding (see, for instance, JP A Hei 05-002195). The light waves outputted from the lithium niobate optical waveguide having such a structure are eccentric and show characteristic properties peculiar to the same and accordingly, when coupled with a conventional optical waveguide, this coupling results in a quite high coupling loss on the order of about not less than 1 dB.

A first embodiment of the optical waveguide according to the present invention is one comprising a substrate provided thereon with a core and a cladding, which is characterized in that a refractive index n1 of a material constituting the cladding on the upper side of the core is smaller than a refractive index n2 of a material constituting the cladding on the lateral side of the core and a refractive index n3 of a material constituting the cladding on the lower side of the core. The coupling loss observed when connecting the optical waveguide of the invention with an optical waveguide whose core is formed by the diffusion technique can be significantly reduced by controlling the refractive index n1 of the upper cladding-forming material in such a manner that it is smaller than the refractive indexes n2 and n3 of the lateral cladding-forming and lower cladding-forming materials.

In this specification, the term “cladding on the upper side of the core” or “upper cladding” means the cladding which comes in contact with at least the upper face of the core, but the term sometimes refers to the whole upper cladding continuously extending from the upper side of the core to the upper side of the lateral cladding.

Incidentally, a refractive index of the core is naturally greater than those of the claddings. Therefore, the core-forming material and the cladding-forming material are so selected that a refractive index of the former should be higher than that of the latter.

A thickness of the cladding on the lower side of the core usually ranges from 5 to 30 μm and preferably 7 to 15 μm. The light waves transmitting through the core partially leak out from the core and therefore, a thickness of the cladding should be determined while taking into consideration the degree of leakage. Moreover, the optimum size of the optical waveguide may vary depending on refractive indexes of the core and the cladding, but a thickness of the cladding is preferably so selected that the coupling loss is reduced while taking into consideration the size or the like of the diffusion optical waveguide to be coupled such as a lithium niobate optical waveguide. A thickness of the lateral cladding may be the same as that of the core layer or may be higher than the upper face of the core by about 2 to 10 μm. A thickness of the core layer in general ranges from 3 to 15 μm and preferably 3 to 5 μm. In addition, a width of the core layer usually ranges from 3 to 15 μm and preferably 3 to 10 μm. In any case, a thickness and width of the core are preferably so selected that the coupling loss is reduced and they are in good agreement with those of the core of the diffusion optical waveguide to be coupled such as a lithium niobate optical waveguide.

In a preferred embodiment of the present invention, resins are used as the core-forming material and the materials constituting the cladding on the lateral and lower sides of the core. Examples of such resins are those selected from the group consisting of polyimide resins, acrylic resins, epoxy resins, phenolic resins, silicone resins, and fluorocarbon resins. As to these resins, one should refer to the explanation of resins as will be described below in connection with the material for forming the cladding on the upper side of the core. In particular, fluorinated polyimide resins are preferably used as the core-forming material and the materials constituting the cladding on the lateral and lower sides of the core.

A refractive index n2 of the material constituting the cladding on the lateral side of the core and a refractive index n3 of the material constituting the cladding on the lower side of the core may appropriately be designed depending on the purpose of the resulting optical waveguide and when using, for instance, a fluorinated polyimide resin, they in general fall within the range of from 1.50 to 1.57.

In the present invention, it is preferred that a refractive index n1 of the material constituting the cladding on the upper side of the core, a refractive index n2 of the material constituting the cladding on the lateral side of the core and a refractive index n3 of the material constituting the cladding on the lower side of the core satisfy the following relation: n1≦nx×0.974 (provided that nx represents a smaller value selected from n2 and n3).

In other words, it is preferred that the difference in refractive index between n1 and n2 or n3: [(n1-n2)/n1]×100 or [(n1-n3)/n1]×100 should be not less than 2.6%.

More preferably, these refractive indexes should satisfy the relation: n1≦nx×0.970 (provided that nx represents a smaller value selected from n2 and n3). Further, these refractive indexes preferably satisfy the following relation: nx×0.600≦n1 (provided that nx represents a smaller value selected from n2 and n3).

Examples of materials constituting the cladding on the upper side of the core are members selected from the group consisting of air, SiO₂, acrylic resins, polyimide resins, epoxy resins, phenolic resins, silicone resins, and fluorocarbon resins.

In this respect, the term “air” as the upper cladding-forming material means that the upper side of the core is exposed to the air.

When air is used as the material for forming the cladding on the upper side of the core and, for instance, the difference in the refractive index between the cladding and the core becomes too high, the optical waveguide of the invention may be so designed that a transparent thin film is arranged on the upper side of the core so that both of the thin film and air can serve as the cladding. In this case, it is possible to select a material having a refractive index higher than that of the core-forming material as the transparent thin film-forming material. In this respect, however, if using a material having a refractive index higher than that of the core-forming material, the confinement of light waves in the core pattern may be impaired or reduced and therefore, it would be necessary to design the thin film in such a manner that it is not too thin. In this way, the desired function of the cladding on the upper side of the core can be realized using at least two kinds of materials to thus ensure the coordination with the form of the mode distribution corresponding to the refractive index distribution observed for the lithium niobate optical waveguide or other diffusion optical waveguides and to thus reduce the coupling loss.

Silicone resins are divided into those having silane chains and those having siloxane chains and include polymers having chain structures and those having network structures, depending on the starting materials selected. Examples of silicone resins having siloxane chains include poly(dimethyl siloxane) and poly(methyl phenyl siloxane). Examples of silicone resins having silane chains include poly(dimethyl silane) and poly(methyl phenyl silane).

Examples of fluorocarbon resins include fluorinated polyimides, fluorinated acrylic resins, fluorinated epoxy resins, fluorine atom-containing alicyclic resins, resins having perfluoro-alicyclic structures, poly(tetrafluoroethylene), poly(tri-fluorinated ethylene chloride), and poly(vinylidene fluoride). Amorphous resins are preferred rather than crystalline ones from the viewpoint of the transmission loss.

In another preferred embodiment of the present invention, the materials constituting at least two portions selected from the core, the cladding on the upper side of the core, the cladding on the lateral side of the core and the cladding on the lower side of the core are different two materials selected from the group consisting of air, SiO₂, acrylic resins, polyimide resins, epoxy resins, phenolic resins, silicone resins, and fluorocarbon resins. The reason for this is as follows.

As has been described above, the optical waveguide of the present invention is preferably so designed that the ratio of a refractive index n1 of the material constituting the cladding on the upper side of the core to a smaller one selected from a refractive index n2 of the material constituting the cladding on the lateral side of the core and a refractive index n3 of the material constituting the cladding on the lower side of the core is not more than 0.974. However, it may sometimes be difficult to select materials whose refractive index ratio is not more than 0.974 from among the same kind of resin materials.

As for SiO₂, a refractive index thereof can be changed by doping the same with, for instance, Ge or F. If SiO₂ is doped with, for instance, GeO₂, however, a refractive index is changed to about 1.02 time (0.98 as expressed in terms of the reciprocal) that of the original one even when it is doped with the same at a dose of 20%.

When selecting air as such materials, the refractive index thereof is about 1, while refractive indexes of other dielectric materials are on the order of about 1.3 (refractive index ratio of about 0.77) to 1.8 (refractive index ratio of about 0.56). Accordingly, a refractive index difference on the order of not more than 0.974 is easily realized by properly combining air with other materials. In this case, however, the surface of the core is exposed to the air and therefore, it is preferred to protect the surface thereof by appropriately devising the package structure or to take a measure to protect the surface thereof from any contamination and/or damage possibly encountered during the module-assembling process. Alternatively, a protective layer is preferably formed on the surface to thus solve the foregoing problems. A thickness of such a surface protective layer may be reduced inasmuch as the resulting waveguide can show desired functions and therefore, the protective film-forming material is not necessarily a transparent material insofar as the presence thereof is not adversely and significantly affect the effect of reducing the transmission loss. Moreover, when the protective layer is a thin film, the protective layer can be arranged without exerting any significant effect on the principal purpose of the present invention or on the realization of the mode-field shape required for the desired coupling with, for instance, a diffusion optical waveguide. More preferably, when a protective layer of this type is arranged, the mode-field shape should be optimized while taking into consideration the refractive index of the protective layer.

When using resin materials listed above such as acrylic resins, polyimide resins, epoxy resins, phenolic resins, silicone resins, and fluorocarbon resins, cured products having different refractive indexes can be produced by selecting such resins in such a manner that the raw materials or monomers selected have considerably different molecular volumes and/or polarizabilities. Such a cured resin product can be formed by the polymerization of monomers, but it would be effective that the different kinds of monomers selected on the basis of the foregoing standpoint are copolymerized in order to prepare cured products having refractive indexes different from one another in a desired rate.

For instance, in case of polyimide resins, a refractive index of the resulting resin can be reduced by the copolymerization of fluorine atom-containing monomers to thus give a fluorinated polyimide. More specifically, the polyimide free of any fluorine atom has a refractive index of about 1.7, while a refractive index of a fluorinated polyimide can be reduced to about 1.5. In this case, the ratio of these refractive indexes is equal to about 0.88. This is mainly due to the fact that the fluorine atom-containing monomer has a molecular volume greater than that of the monomer free of any fluorine atom.

On the other hand, the materials selected for forming the optical waveguide of the present invention preferably have low transparency within a wavelength region used (low transmission loss). In this respect, the magnitude of the transmission loss can be judged on whether the overall loss is reduced or not. More specifically, the overall loss can be divided into the coupling loss and the transmission loss and the latter can be represented by the following relation: [the transmission loss per unit length (in case where it is expressed in terms of dB unit)]×[the propagation distance]. As will be described below, the present invention permits the reduction of the coupling loss in a rate of 0.5 to 0.7 dB per coupled part as compared with the conventional optical waveguide structure. Therefore, if the number of coupled part is set at 1 and the length of the optical waveguide according to the present invention is assumed to be 5 mm, it is preferred to construct an optical waveguide having a transmission loss of not more than about 0.1 dB/mm. Accordingly, it is preferred that one should select materials so as to be in accord with this purpose.

When using, for instance, light waves having wavelengths falling within a near infrared region such as 1310 nm band and 1550 nm band currently used in the optical communication, it is preferred to select fluorine atom-containing resins including, for instance, fluorinated polyimide resins, fluorinated epoxy resins and fluorinated acrylic resins and/or silicone resins from the viewpoint of the reduction in the transmission loss.

In case of fluorinated polyimide resins which may preferably used herein, a refractive index difference on the order of about 3% can be realized by changing the copolymerization ratio of monomers while maintaining the transparency of the resulting copolymer and accordingly, a combination of resin materials which satisfy the requirement of the refractive index difference of not more than 0.974 can easily be found out by the use of the same kind of resins which differ in their compositions.

In addition, fluorinated polyimide resins have higher heat resistance and therefore, it is also preferred to select the fluorinated polyimide resin while taking into consideration the subsequent processes such as the vapor-deposition of electrodes and the soldering step.

On the other hand, a cured product having a higher refractive index can be prepared by the copolymerization of sulfur (S)-containing monomers and therefore, this technique would permit the production of resins which can provide a desired refractive index ratio.

Alternatively, a refractive index of the resulting cured product may likewise be adjusted by the control of the curing process conditions such as curing time and temperature, depending on the kind of the resin and accordingly, a refractive index of the resulting resin can be controlled by curing the cladding layers and core layer according to the curing processes or under the curing conditions different from one another.

Alternatively, in other kinds of resins, a refractive index thereof can be increased or decreased by the irradiation thereof with radiant rays such as visible light waves, ultraviolet rays and electron beams. For this reason, these techniques may be used in the production of the optical waveguide of the present invention.

The substrate which may be used in the production of the optical waveguide of the present invention may be any one, but specific examples thereof include those made of inorganic materials such as those prepared from glass, quartz, silicon, silicon oxide, silicon nitride, aluminum, aluminum oxide, aluminum nitride, tantalum oxide, and gallium arsenide; and those made of resins such as those prepared from polyimide resins, epoxy resins, phenolic resins, silicone resins and fluorocarbon resins.

Incidentally, as to these resins, one can refer to the description of the core-forming and cladding-forming materials given later.

If refractive indexes of optical waveguides which are mutually connected together are different from one another because of the difference in the materials for forming them, this difference in refractive index may sometimes contribute to an increase in the Fresnel's loss. When selecting these materials in the present invention, the Fresnel's loss can be reduced by controlling a refractive index of, in particular, the core-forming material such that it approaches that of the another optical waveguide to be coupled. The Fresnel's loss should be taken into consideration in such a case where it is high on the order of about 0.7 dB encountered when a refractive index ratio is not less than 2 as in case of a combination of lithium niobate and air, but it is only about 0.19 dB when coupling quartz with lithium niobate and therefore, the loss does not play a principal role in the overall loss concerning the coupling of two optical waveguides.

When coupling with a diffusion optical waveguide such as a lithium niobate optical waveguide and selecting materials for producing an optical waveguide to be coupled, in particular, the material for forming the core from, for instance, resins, it is preferred to select a resin having a high refractive index. Specifically, when selecting, for instance, a fluorinated polyimide and a non-fluorinated polyimide, the Fresnel's losses can be reduced to 0.15 dB and 0.1 dB, respectively, while the loss is about 0.19 dB in case of quartz.

Then embodiments of the optical waveguide of the present invention will be described in more detail with reference to the accompanying drawings.

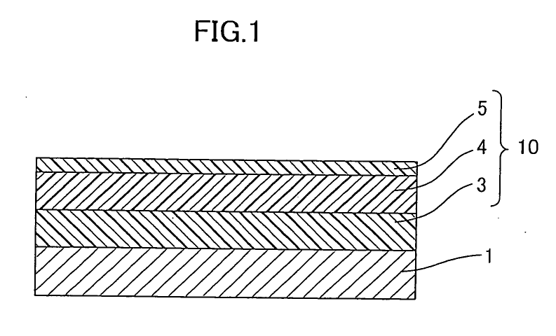

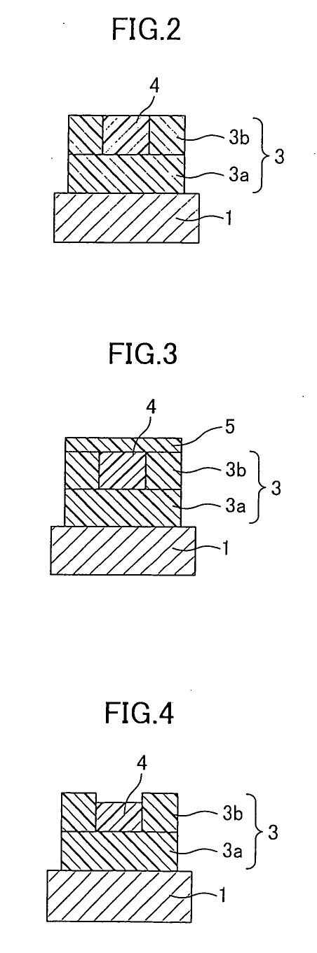

FIG. 1 shows a laminated optical waveguide 10 formed on a silicon wafer 1. FIG. 2 is a cross-sectional view of the optical waveguide shown in FIG. 1 and viewed from the direction along which light waves propagate. In FIG. 2, the laminated optical waveguide 10 comprises a lower cladding 3a formed on the silicon wafer 1, a core 4 mounted on the lower cladding, and a lateral cladding 3b formed on the lateral side of the core 4. The lower cladding 3a and the lateral cladding 3b may integrally be formed from the same material or may separately be formed depending on the method for the preparation of the laminate 10. The lower cladding 3a and the lateral cladding 3b are sometimes referred to as a cladding comprehensively. Both of the lower cladding 3a and the lateral cladding 3b are formed from a cladding-forming polyimide resin coating (having a refractive index of, for instance, 1.514), a thickness of the lower cladding 3a is about 10 μm and that of the lateral cladding 3b corresponds to about 3.5 μm from the surface of the lower cladding 3a. The core 4 is formed from a core-forming polyimide resin coating, a thickness thereof is about 3.5 μm and a width thereof is about 6.5 μm. Present above the core is air (having a refractive index of 1.00). In this case, the air serves as the upper cladding of this waveguide.

FIG. 3 shows another embodiment of the optical waveguide of the present invention.

The lower cladding 3a and the lateral cladding 3b are formed from a cladding-forming polyimide resin coating (having a refractive index of, for instance, 1.514), a thickness of the lower cladding 3a is about 10 μm and that of the lateral cladding 3b corresponds to about 3.5 μm from the surface of the lower cladding 3a. The core 4 is formed from a core-forming polyimide resin coating, a thickness thereof is about 3.5 μm and a width thereof is about 6.5 μm.

A cladding 5 consisting of SiO₂ is present on the core 4 and a thickness thereof is about 2 μm.

A refractive index of SiO₂ is about 1.46, which is smaller than that of the cladding-forming material constituting the lower cladding 3a and the lateral cladding 3b.

FIG. 4 shows still another embodiment of the optical waveguide of the present invention.

The lower cladding 3a and the lateral cladding 3b are formed from a cladding-forming polyimide resin coating (having a refractive index of, for instance, 1.514), a thickness of the lower cladding 3a is about 10 μm and that of the lateral cladding 3b corresponds to about 5.5 μm from the surface of the lower cladding 3a. The core 4 is formed from a core-forming polyimide resin coating, a thickness thereof is about 3.5 μm and a width thereof is about 6.5 μm.

Such an embodiment in which a layer of air (refractive index: 1.00) is present only on the top face of the core 4 would permit the reduction of the coupling loss observed when it is coupled with a lithium niobate optical waveguide.

There will now be described below a specific example of the method for determining the cross-sectional structure of an optical waveguide for coupling (of the present invention) favorably connected to an optical waveguide to be coupled.

First of all, a mode-field profile typical of the optical waveguide to be coupled is provided.

This may be obtained by experimentally determining the near field pattern.

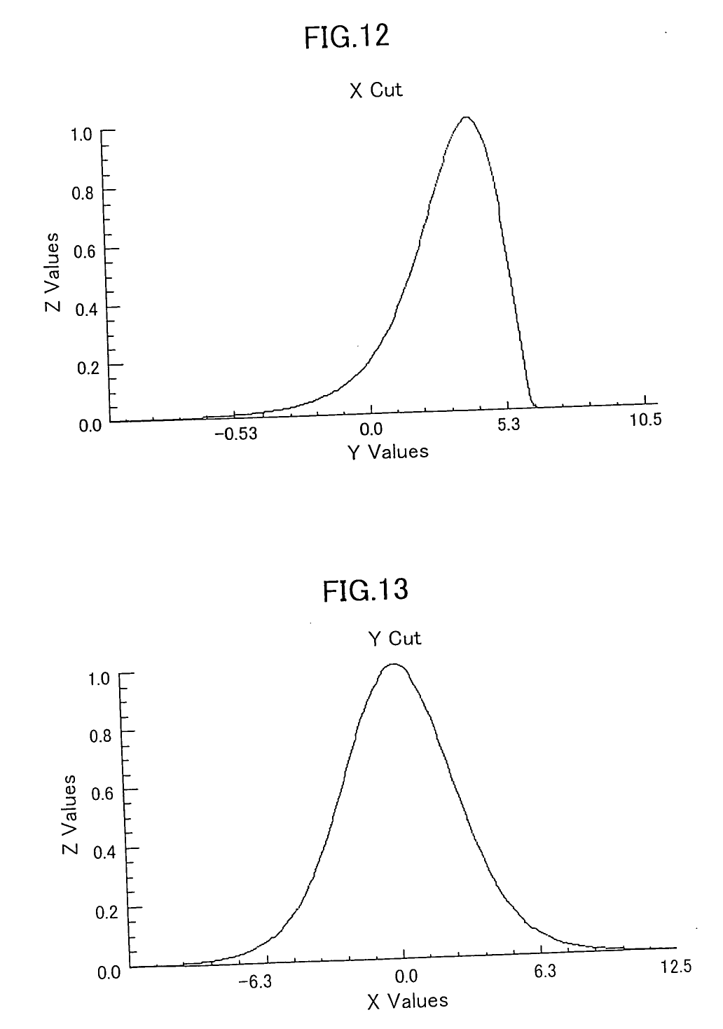

FIG. 12 shows the mode-field profile, in the vertical direction (in the direction along the depth), of an optical waveguide to be coupled used for the calculation of the coupling loss and FIG. 13 shows the mode-field profile, in the horizontal direction (in the direction along a width), of an optical waveguide to be coupled, used for the calculation of the coupling loss.

In practice, it is preferred to provide the profile in the two-dimensional cross-section.

A refractive index distribution of the core of the optical waveguide to be coupled can be estimated on the basis of this information.

In case shown in FIG. 12, the upper portion of the core corresponds to the right hand side of the abscissa on the graph, while the lower portion of the core corresponds to the left hand side of the abscissa on the graph and the data shown in FIG. 12 indicate that the refractive index of the core is gradually reduced towards the direction along the depth.

For this reason, a refractive index distribution of the optical waveguide for coupling of the invention should be so designed that it has a refractive index distribution in which a refractive index upwardly increases.

It is assumed that the materials used for forming an optical waveguide for coupling are SiO₂ for the upper cladding and a fluorinated polyimide for the core and the lateral and lower claddings. In this case, refractive indexes are set at levels of, for instance, 1.522 for the core, 1.46 for the upper cladding and 1.514 for the lateral and lower claddings.

It is desirable for the cladding to have a size or such a thickness that the light waves confined within the core are satisfactorily attenuated. For instance, the cladding is arranged at a position 10 to 20 μm apart from the core although a thickness may vary depending on refractive indexes of the core and the cladding. In this case, a thickness of the upper cladding is set at a level of 5 μm and those of the lower and lateral claddings are assumed to be 10 μm.

Then the mode-field profile of the optical waveguide for coupling is calculated while variously changing the size of the core in the direction along a thickness and/or width. The mode-field profile thereof can easily be calculated using a commercially available software for simulation. Examples of such software for simulation usable herein include one called BPM-CAD available from Optiwave Company. Moreover, it is necessary to obtain the integrated value (or coupling loss) of the overlapping area between the mode-field profiles of the optical waveguide for coupling and the optical waveguide to be coupled.

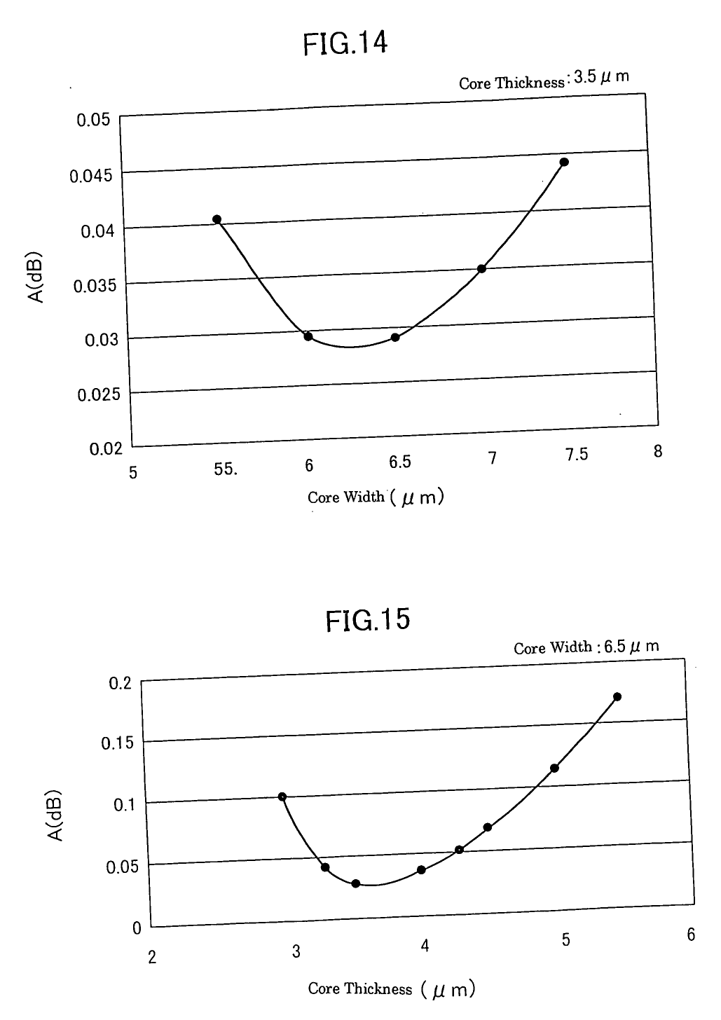

FIGS. 14 and 15 show the calculated coupling loss values obtained when the core width and core thickness of the optical waveguide are changed, respectively. An optimum width and thickness of the core can be determined on the basis of the data plotted on these figures.

In case as shown in FIGS. 14 and 15, it is found that the optimum coupling loss can be obtained when the core width ranges from 6 to 6.5 μm and the core thickness ranges from about 3.5 to 4 μm.

An optical waveguide for coupling can easily be produced as shown in the following Example, on the basis of the core-forming material (refractive index) and the size of the core, in the cross-section, thus determined.

[Preparation Method]

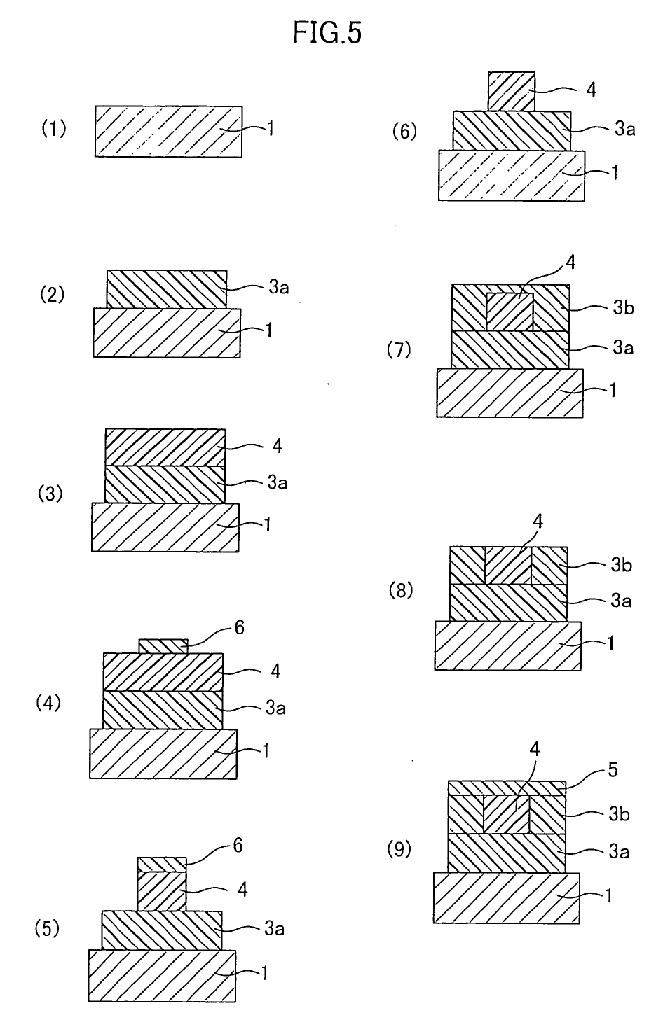

A first embodiment of the method for producing the foregoing optical waveguide according to the present invention will now be described in more detail with reference to FIGS. 5(1) to 5(8).

First, a solution of the precursor for a lower cladding-forming polyimide is applied onto the entire top surface of a silicon substrate 1 (FIG. 5(1)) to form a liquid coating of the material, followed by drying the liquid coating with heating to thus make the solvent evaporate off and subsequent curing of the layer by further heating it at a higher temperature to thus form a lower cladding 3a consisting of the polyimide resin coating (FIG. 5(2)).

The solution of the precursor for a lower cladding-forming polyimide is coated according to the method such as the spin-coating method, the cast-coating method, the roll-coating method, and the dip-coating method. Among them, preferably used herein is the spin-coating method.

A solution of the precursor for a core-forming polyimide is applied onto the lower cladding 3a to form a liquid coating of the material, followed by drying the liquid coating with heating to thus make the solvent evaporate off and subsequent curing of the layer by further heating it at a higher temperature to thus form a core-forming polyimide resin coating 4 (FIG. 5(3)). The solution of the precursor may be applied onto the lower cladding according to the same method used for coating the lower cladding-forming polyimide precursor solution.

A resist is then coated on the core-forming polyimide resin coating 4 using a spin-coater, the resist layer is then dried, exposed to light waves and then developed to form a patterned resist layer 6. This patterned resist layer 6 serves as a mask for processing the core-forming polyimide resin coating 4 into a desired core shape (FIG. 5(4)).

The core-forming polyimide resin coating 4 can then be processed through the patterned resist layer 6 as a mask according to the oxygen-reactive ion etching method (O₂-RIE) to thus form a desired core 4 (FIG. 5(5)).

Thereafter the patterned resist layer 6 is peeled off (FIG. 5(6)).

Then a solution of a cladding-forming polyimide precursor is coated so as to cover the core 4 and the lower cladding 3i a. The coating method may be the same as those listed above.

Then the coating of the solution of the cladding-forming polyimide precursor is dried with heating to allow the solvent to evaporate off and the coating is subsequently cured by further heating the same at a higher temperature to thus form a cladding layer 3b consisting of the cladding-forming polyimide resin coating (FIG. 5(7)).

Furthermore, the cladding-forming polyimide resin coating 3b is removed through etching till the top surface of the core 4 is exposed to thus form a lateral cladding 3b consisting of the cladding-forming polyimide resin coating (FIG. 5(8)).

As has been described above, an optical waveguide is produced and this waveguide has a core whose top surface is exposed to the air or it has an upper cladding consisting of air.

Examples of means for removing the cladding-forming polyimide resin coating 3b till the top surface of the core 4 is exposed are the dry etching technique, the wet-etching technique and the polishing with an abrasive.

Examples of dry-etching techniques are the plasma etching, reactive ion etching, reactive sputter etching, and ion beam etching techniques and preferably used herein is the reactive ion etching technique since this technique permits the anisotropic etching. The controlling factors in these techniques include, for instance, the gas composition, the pressure thereof, the temperature, the frequency, and the output. Therefore, these factors or conditions can appropriately be selected depending on the intended purposes.

The wet etching technique is an etching technique which is carried out in a liquid phase and which makes use of a chemical reaction. This etching technique employs chemical reagents, for instance, acids such as hydrofluoric acid; alkalis such as alkali hydroxides and ethylene diamine; and oxidizing agents such as potassium permanganate. Examples of reaction methods are the dipping, running water, spraying, jet and electrolyzation methods. The controlling factors in these methods include, for instance, the composition of liquids used, the pH value thereof, the temperature thereof, the stirring conditions, the processing time and the area already processed and they may appropriately be selected depending on the intended purposes.

In this embodiment of the present invention, a polyimide resin is used and therefore, usable herein as etchants are aqueous solutions of potassium hydroxide and sodium hydroxide; mixed solutions of hydrazine and isopropyl alcohol; and mixed aqueous solutions of ethylenediamine and pyrocatechol, these etchants being warmed prior to the practical use.

In the polishing technique using an abrasive, examples of such abrasives used include colloidal silica, barium carbonate, iron oxide, calcium carbonate, silica, cerium oxide, and diamond and the polishing methods usable herein include, for instance, mechanical and mechano-chemical polishing methods. This method is preferred since the surface to be processed is uniformly polished, but care should be taken not to form any polishing mark.

Then a second embodiment of the method for preparing the optical waveguide of the present invention will be described in detail with reference to the attached FIGS. 5(1) to 5(9).

The same procedures as shown in FIGS. 5(1) to 5(8) and used in the aforementioned first embodiment are repeated to thus expose the top surface of the core to the air.

Then an upper cladding-forming material is applied onto the lateral cladding 3b and the top surface of the core 4 to thus form an upper cladding 5 whose top face is almost flat and whose thickness is 2 μm (FIG. 5(9)). When the upper cladding-forming material is SiO₂, the upper cladding may be formed by any known film-forming technique such as the CVD technique and the vapor deposition or evaporation technique.

Alternatively, such an upper cladding may likewise be formed by the solution coating method such as SOG. In addition, if the upper cladding-forming material is an acrylic resin, the upper cladding may be formed by any known film-forming technique such as the spin-coating and the vapor deposition-polymerization method and these method may provide a flat coating.

Then a third embodiment of the preparation method of the present invention will be described in detail below.

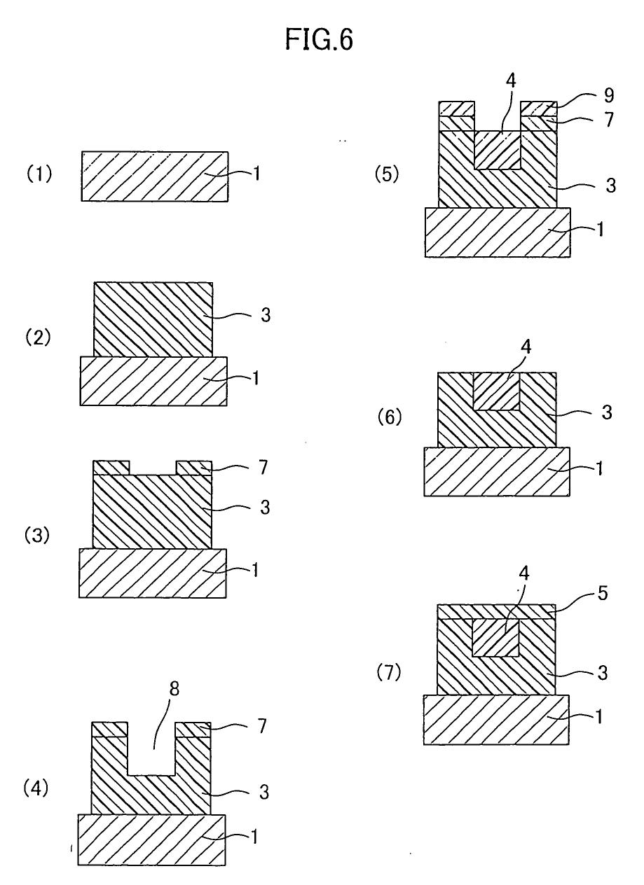

First, a solution of a cladding-forming polyimide precursor is applied onto the entire top surface of a silicon substrate 1 (FIG. 6(1)) to form a liquid coating of the material, followed by drying the liquid coating with heating to thus make the solvent evaporate off and subsequent curing of the layer by further heating it at a higher temperature to thus form a cladding 3 consisting of the polyimide resin coating (FIG. 6(2)).

A resist is then coated on the cladding 3 using a spin-coater, the resist layer is then dried, exposed to light waves and then developed to form a patterned resist layer 7. This patterned resist layer 7 serves as a mask for processing the cladding-forming polyimide resin coating 3 into a desired shape of a core 4 (FIG. 6(3)).

The cladding-forming polyimide resin coating 3 can then be processed through the patterned resist layer 7 as a mask according to the oxygen-reactive ion etching method (O₂-RIE) to thus form a concaved portion 8 having a desired core shape (FIG. 6(4)).

The concaved portion 8 is filled with a solution of a core-forming polyimide precursor, followed by drying the solution within the concaved portion with heating to thus make the solvent evaporate off and subsequent curing of the resin by further heating it at a higher temperature to thus form a core 4 (FIG. 6(5)). The optical waveguide thus prepared, whose upper side is exposed to the air may be used without any further treatment. Moreover, it is also possible to remove the core-forming polyimide 9 and the resist 7 (FIG. 6(6)).

As has been described above, an optical waveguide is produced and this waveguide has a core whose top surface is exposed or it has an upper cladding consisting of air. In this respect, it is also possible to produce an optical waveguide in which a cladding-forming material is further applied onto the core-forming material as shown in FIG. 6(5).

Next, a fourth embodiment of the production method will be detailed below with reference to FIGS. 6(1) to 6(7).

The same procedures as shown in FIGS. 6(1) to 6(6) and used in the aforementioned third embodiment are repeated to thus form an optical waveguide whose upper side is exposed to the air.

Then an upper cladding-forming material is applied onto the lateral cladding 3b and the top surface of the core 4 to thus form an upper cladding 5 whose top face is almost flat (FIG. 6(7)). The upper cladding can be formed by any known film-forming technique such as the spin-coating and the vapor deposition-polymerization method and these method may provide a flat coating. A thickness of the coating is 2 μm.

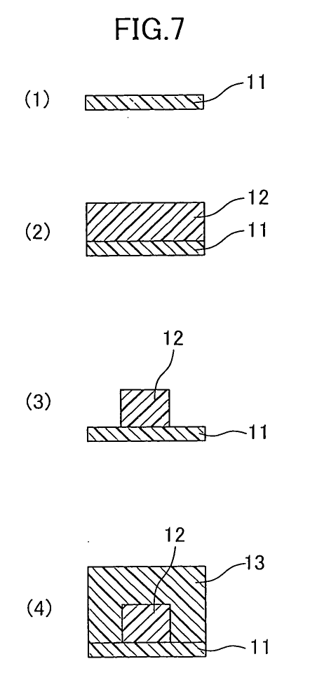

Then a fifth embodiment of the production method will be detailed below with reference to FIGS. 7(1) to 7(4).

First, a glass plate 11 is provided, a solution of a core-forming polyimide precursor is applied onto the surface of the glass plate 11 to thus form a core layer 12 (FIGS. 7(1), (2)).

A resist is coated on the foregoing core layer 12, followed by drying the coated resist, patterning through an optical waveguide-shaped mask pattern to form a core 12 and peeling off of the resist layer (FIG. 7(3)).

Subsequently, a solution containing a cladding-forming polyimide precursor is coated till the top surface of the core 12 is completely covered with the solution and then dried to give a cladding layer 13 on the lateral side of the core and the upper side thereof (FIG. 7(3)).

The optical waveguide thus produced is used in its inverted state. In other words, the glass plate serves as the cladding on the upper side of the core in this optical waveguide. It is a matter of course that other optical waveguides according to the present invention can likewise be produced using materials capable of serving as the upper cladding instead of the glass plate. For instance, such a material may be one comprising a silicon substrate and an SiO₂ layer formed thereon. In this case, the upper side of the core and the upper side of the lateral cladding are formed on the glass plate and therefore, this technique would permit the formation of a flat boundary without any difficulty. Moreover, the number of production steps can be reduced and therefore, the production cost can considerably be saved.

### EXAMPLES

### Example 1

An optical waveguide was prepared using the materials and conditions specified below according to the first embodiment of the production method.

[Materials]

Lower and Lateral Claddings 3 (3a and 3b): Polyimide coatings produced using a cladding-forming polyimide precursor (OPI-N3105 (Trade Name) available from Hitachi Chemical Co., Ltd.) (a product produced by first heating the coating to 100° C. for 30 minutes and then 200° C. for 30 minutes to thus make the solvent evaporate off and then curing the coating through heating at 370° C. for 60 minutes) (a thickness of the lower cladding 3a is about 10 μm, that of the lateral cladding 3b is about 3.5 μm and a refractive index thereof is 1.514).

Core 4: A polyimide coating produced using a core-forming polyimide precursor (OPI-N3305 (Trade Name) available from Hitachi Chemical Co., Ltd.) (a product produced by first heating the coating to 100° C. for 30 minutes and then 200° C. for 30 minutes to thus make the solvent evaporate off and then curing the coating through heating at 350° C. for 60 minutes) (the resulting core has a thickness of about 3.5 μm, a width of about 6.5 μm and a refractive index of 1.522).

Material for Forming Cladding on the Upper Side of Core: See Table 1

Photoresist 6: RU-1600P (Trade Name of a product available from Hitachi Chemical Co., Ltd.).

[Conditions for Production]

A coating method using a spin-coater is used for the application of the foregoing solution containing the core-forming polyimide precursor, and those each containing the lateral cladding-forming or lower cladding-forming polyimide precursor.

### Examples 2 to 4

Optical waveguides specified in Table 1 were produced according to the second and third embodiments of the production method in place of the first embodiment (Examples 2 to 4). The following are the materials and the production conditions used in these Examples.

### Example 2

[Materials]

Lower and Lateral Claddings 3 (3a and 3b): Polyimide coatings produced using a cladding-forming polyimide precursor (OPI-N3105 (Trade Name) available from Hitachi Chemical Co., Ltd.) (a product produced by first heating the coating to 100° C. for 30 minutes and then 200° C. for 30 minutes to thus make the solvent evaporate off and then curing the coating through heating at 370° C. for 60 minutes) (a thickness of the lower cladding 3a is about 10 μm, that of the lateral cladding 3b is about 3.5 μm and a refractive index thereof is 1.514).

Core 4: A polyimide coating produced using a core-forming polyimide precursor (OPI-N3305 (Trade Name) available from Hitachi Chemical Co., Ltd.) (a product produced by first heating the coating to 100° C. for 30 minutes and then 200° C. for 30 minutes to thus make the solvent evaporate off and then curing the coating through heating at 350° C. for 60 minutes) (the resulting core has a thickness of about 3.5 μm, a width of about 6.5 μm and a refractive index of 1.522).

Material for Forming Cladding on the Upper Side of Core: See Table 1 Photoresist 6: RU-1600P (Trade Name of a product available from Hitachi Chemical Co., Ltd.).

[Conditions for Production]

HSG-R7 was coated by the spin-coating technique and then heated to thus form an SiO2 layer having a thickness of about 2 μm.

### Example 3

[Materials]

Lower and Lateral Claddings 3 (3a and 3b): Polyimide coatings produced using a cladding-forming polyimide precursor (OPI-N3105 (Trade Name) available from Hitachi Chemical Co., Ltd.) (a product produced by first heating the coating to 100° C. for 30 minutes and then 200° C. for 30 minutes to thus make the solvent evaporate off and then curing the coating through heating at 370° C. for 60 minutes) (a thickness of the lower cladding 3a is about 10 μm, that of the lateral cladding 3b is about 3.5 μm and a refractive index thereof is 1.514).

Core 4: A polyimide coating produced using a core-forming polyimide precursor (OPI-N3305 (Trade Name) available from Hitachi Chemical Co., Ltd.) (a product produced by first heating the coating to 100° C. for 30 minutes and then 200° C. for 30 minutes to thus make the solvent evaporate off and then curing the coating through heating at 350° C. for 60 minutes) (the resulting core has a thickness of about 3.5 μm, a width of about 6.5 μm and a refractive index of 1.522).

Material for Forming Cladding on the Upper Side of Core: See Table 1

Photoresist 6: RU-1600P (Trade Name of a product available from Hitachi Chemical Co., Ltd.).

Upper Cladding 5: Acrylic Resin (PMMA, about 2 μm)

[Conditions for Production]

Each material was dissolved in a solvent (ethyl cellosolve), coated according to the spin-coating method and then heated (at 150° C.) to remove the solvent.

### Example 4

[Materials]

Lower and Lateral Claddings 3 (3a and 3b): Polyimide coatings produced using a cladding-forming polyimide precursor (OPI-N3105 (Trade Name) available from Hitachi Chemical Co., Ltd.) (a product produced by first heating the coating to 100° C. for 30 minutes and then 200° C. for 30 minutes to thus make the solvent evaporate off and then curing the coating through heating at 370° C. for 60 minutes) (a thickness of the lower cladding 3a is about 10 μm, that of the lateral cladding 3b is about 3.5 μm and a refractive index thereof is 1.514).

Core 4: A polyimide coating produced using a core-forming polyimide precursor (OPI-N3305 (Trade Name) available from Hitachi Chemical Co., Ltd.) (a product produced by first heating the coating to 100° C. for 30 minutes and then 200° C. for 30 minutes to thus make the solvent evaporate off and then curing the coating through heating at 350° C. for 60 minutes) (the resulting core has a thickness of about 3.5 μm, a width of about 6.5 μm and a refractive index of 1.522).

Material for Forming Cladding on the Upper Side of Core: See Table 1

Photoresist 7: RU-1600P (Trade Name of a product available from Hitachi Chemical Co., Ltd.).

### Comparative Example 1

[Conditions for Production]

The same procedures used in the second embodiment of the production method were repeated except that the polyimide resin listed in Table 1 was substituted for the acrylic resin as the upper cladding-forming material to thus produce an optical waveguide.

TABLE 1

| | | | Diff. in Refractive Ind. | |
|---|---|---|---|---|
| | Cross-sectional | Cladding-forming Material | (%)¹⁾ between n1 and | Coupling |
| Ex. | shape of optical | on Upper Side of Core | n2²⁾; and between | Loss |
| No. | waveguide laminate | (Refractive Ind. n1) | n1 and n3³⁾ | (dB) |
| 1 | See FIG. 2 | Air (1.00) | 34%/34% | 0.3 |
| 2 | See FIG. 3 | SiO₂ (1.46) | 3.3%/3.3% | 0.4 |
| 3 | See FIG. 3 | Acrylic resin (1.46) | 3.3%/3.3% | 0.4 |
| 4 | See FIG. 4 | Air (1.00) | 34%/34% | 0.5 |
| 1* | See FIG. 9 | OPI-N3105 (1.514) | 0/0 | 1.0 |

*Comparative Example
¹⁾[(n1 − n2)/n1] × 100; [(n1 − n3)/n1] × 100
²⁾n2: A refractive index of the cladding-forming material on the lateral side of the core;
³⁾n3: A refractive index of the cladding-forming material on the lower side of the core.

Each of the optical waveguides prepared according to the procedures described above was inspected for the optical characteristics and the coupling loss (Table 1) observed when it was coupled with a lithium niobate optical waveguide was determined according to the following method.

The lithium niobate optical waveguide used herein was prepared as follows:

First, an LD, two optical fibers and a PD were connected in this order and the intensity of a laser light beam having a wavelength of 1550 nm was determined at the PD.

Then the lithium niobate optical waveguide was sandwiched between the two optical fibers and the intensity of the light passing therethrough was determined. The length of the lithium niobate optical waveguide was changed to 7.5 mm and 15 mm and the intensities of the light passing therethrough were likewise determined and the results were plotted on a graph wherein the length of the waveguide was plotted as abscissa and the light intensity as ordinate. In this connection, the slope of the graph represents the transmission loss and the Y-intercept represents the coupling loss, respectively.

Then the optical waveguide of the present invention was likewise inspected for the transmission loss and the coupling loss by repeating the same procedures used above.

Then the lithium niobate optical waveguide and the optical waveguide of the present invention were sandwiched between the foregoing two optical fibers and the intensity of the light passing therethrough was determined and the coupling loss observed when coupling the lithium niobate optical waveguide with the optical waveguide of the present invention was calculated by subtracting the foregoing coupling losses observed for the lithium niobate optical waveguide and the optical waveguide of the present invention from the resulting coupling loss.

As will be seen from the data shown in Table 1, the use of the optical waveguide of the present invention permits the reduction of the coupling loss observed when coupling the same with a lithium niobate optical waveguide (Examples 1 to 4). In particular, preferred is the optical waveguide produced in Example 1 wherein the top surface of the core is exposed to the air or wherein the air layer is used as the upper cladding, since this waveguide permits the reduction of the number of production steps and the substantial reduction of the coupling loss.

### INDUSTRIAL APPLICABILITY

The optical waveguide of the present invention can be coupled, at a low coupling loss, with an optical waveguide, for instance, a diffusion optical waveguide or an ion-exchange optical waveguide such as a lithium niobate optical waveguide, in which the cross-sectional pattern of the core thereof is not symmetric in the direction along the depth of the substrate thereof and the optical waveguide is quite useful as a high quality optical waveguide for use in the optical interconnection and the present invention permits the production of such an optical waveguide in large quantities and at a reasonable price.

In addition to the coupling of a diffusion optical waveguide with another diffusion optical waveguide (or another port of the same diffusion optical waveguide), the optical waveguide of the present invention can be used in such a manner that it lies between an optical fiber and a diffusion optical waveguide coupled together or that it lies between a diffusion optical waveguide and a semiconductor element such as a semiconductor laser or a semiconductor amplifier. In these cases, the optical waveguide of the invention is preferably has the cross-sectional structure herein described on the side of the coupling with the diffusion optical waveguide. On the side of the coupling with another optical waveguide including an optical fiber) or an optical element, the optical waveguide of the present invention can be so designed that the cross-sectional structure is changed so as to make the cross-sectional structure approach that most suitable for the coupling with these members, while using a technique called the spot size convertor.

The present invention permits the control of the length of the diffusion optical waveguide having a large transmission loss to the necessary smallest limit and the optical waveguide of the present invention having a low transmission loss can be used by coupling the same with other portions.

The present invention can likewise restrict the use of the diffusion optical waveguide having a high production cost to a smallest possible level and the optical waveguide of the present invention can be used in such a state that it is connected to functionally replaceable parts such as curved parts.

According to the present invention, when it is needed to constitute a large-scale (large-area) optical waveguide circuit, the area of the diffusion optical waveguide effectively used is restricted to the smallest possible level, and the optical waveguide of the present invention, which can easily be produced, can be used in such a condition that it is incorporated into the circuit instead.

When coupling the optical waveguide of the invention with a diffusion optical waveguide, they are not necessarily coupled together through vertical end faces and they may also be coupled obliquely. This would permit the prevention of any re-coupling, with the core, of the reflected and returning light waves originated from the difference in the refractive index between the cores of these two optical waveguides. Moreover, the use of the optical waveguide according to such an embodiment in which it is obliquely coupled may largely contribute to the restriction of the use of the foregoing diffusion optical waveguide to the smallest possible level.

1. An optical waveguide which comprises a cladding and a core formed on a substrate, wherein a refractive index n1 of a material constituting the cladding on the upper side of the core is smaller than a refractive index n2 of a material constituting the cladding on the lateral side of the core and a refractive index n3 of a material constituting the cladding on the lower side of the core.

2. The optical waveguide as set forth in claim 1, wherein the refractive index n1 of the material constituting the cladding on the upper side of the core, the refractive index n2 of the material constituting the cladding on the lateral side of the core and the refractive index n3 of the material constituting the cladding on the lower side of the core satisfy the following relation: n1≦nx×0.974 (provided that nx represents a smaller value selected from n2 and n3).

3. The optical waveguide as set forth in claim 1, wherein each of the core material and the materials constituting the cladding on the lateral side of the core and the cladding on the lower side of the core is selected from the group consisting of polyimide resins, acrylic resins, epoxy resins, phenolic resins, silicone resins, and fluorocarbon resins.

4. The optical waveguide as set forth in claim 1, wherein the materials constituting at least two portions selected from the core, the cladding on the upper side of the core, the cladding on the lateral side of the core and the cladding on the lower side of the core are different two materials selected from the group consisting of air, SiO₂, acrylic resins, polyimide resins, epoxy resins, phenolic resins, silicone resins, and fluorocarbon resins.

5. The optical waveguide as set forth in claim 1, wherein the material constituting the cladding on the upper side of the core is a member selected from the group consisting of air, SiO₂, acrylic resins, polyimide resins, epoxy resins, phenolic resins, silicone resins, and fluorocarbon resins.

6. The optical waveguide as set forth in claim 1, wherein the material constituting the cladding on the upper side of the core is a member selected from the group consisting of air, SiO₂ and acrylic resins.

7. The optical waveguide as set forth in claim 3, wherein the materials constituting the claddings and the core are fluorinated polyimide resins.

8. A method for producing an optical waveguide whose upper side of the core is exposed, comprising the following steps:
a first step for forming a lower cladding on a substrate and then further forming a core layer on the lower cladding;
a second step for patterning the core layer in the form of an optical waveguide to thus form a core;
a third step for applying a lateral cladding-forming material onto the surface of the lower cladding and the side of the core till the upper surface of the core is completely covered with the material to thus form a lateral cladding; and
a fourth step for removing the lateral cladding-forming material which covers the upper side of the core till the upper surface of the core is exposed.

9. A method for producing an optical waveguide comprising the following steps:
a first step for forming a lower cladding on a substrate and then further forming a core layer on the lower cladding;
a second step for patterning the core layer in the form of an optical waveguide to thus form a core;
a third step for applying a lateral cladding-forming material onto the surface of the lower cladding and the side of the core till the upper surface of the core is completely covered with the material to thus form a lateral cladding;
a fourth step for removing the lateral cladding-forming material which covers the upper side of the core till the upper surface of the core is exposed; and
a fifth step for applying, onto the top surface of the exposed core, an upper cladding-forming material having a refractive index n1 smaller than a refractive index n2 of the lateral cladding-forming material and a refractive index n3 of the lower cladding-forming material to thus form an upper cladding on the core.

10. A method for producing an optical waveguide whose upper side of the core is exposed, comprising the following steps:
a first step for forming a cladding layer which ultimately serves as a cladding on the lateral side of the core and a cladding on the lower side of the core;
a second step for forming, in the cladding layer, a concaved portion for forming a core; and
a third step for filling the concaved portion for forming a core with a solution of a core-forming material and drying the same to form a core.

11. A method for producing an optical waveguide comprising the following steps:
a first step for forming a cladding layer which ultimately serves as a cladding on the lateral side of the core and a cladding on the lower side of the core;
a second step for forming, in the cladding layer, a concaved portion for forming a core;
a third step for filling the concaved portion for forming a core with a solution of a core-forming material and drying the same to form a core; and
a fourth step for applying, onto the top surface of the core, an upper cladding-forming material having a refractive index n1 smaller than a refractive index n2 of the lateral cladding-forming material and a refractive index n3 of the lower cladding-forming material to thus form an upper cladding on the core.

12. The method as set forth in claim 11, wherein the refractive index n1 of the material constituting the cladding on the upper side of the core, the refractive index n2 of the material constituting the cladding on the lateral side of the core and the refractive index n3 of the material constituting the cladding on the lower side of the core satisfy the following relation: n1≦nx×0.974 (provided that nx represents a smaller value selected from n2 and n3).

13. The method as set forth in claim 11, wherein each of the core material and the materials constituting the cladding on the lateral side of the core and the cladding on the lower side of the core is selected from the group consisting of polyimide resins, acrylic resins, epoxy resins, phenolic resins, silicone resins, and fluorocarbon resins.

14. The method as set forth in claim 11, wherein the material for forming the cladding on the upper side of the core is a member selected from the group consisting of air, SiO₂, acrylic resins, polyimide resins, epoxy resins, phenolic resins, silicone resins, and fluorocarbon resins.

15. A method for producing an optical waveguide comprising a first step for forming a core layer on the surface of a glass substrate; a second step for patterning the core layer in the form of an optical waveguide to thus form a core; and a third step for applying a cladding-forming material onto the product of the second step till the upper surface of the core is completely covered with the material to thus form a cladding layer.

16. The method as set forth in claim 15, wherein a refractive index n5 of the cladding-forming material and a refractive index n4 of the glass substrate satisfy the following relation: n4≦n5×0.974.

17. The method as set forth in claim 15, wherein each of the core-forming material and the cladding-forming material is selected from the group consisting of polyimide resins, acrylic resins, epoxy resins, phenolic resins, silicone resins, and fluorocarbon resins.

18. The method as set forth in claim 13, wherein the polyimide resin is a fluorinated polyimide resin.

19. An optical waveguide (an optical waveguide for coupling) which is used for coupling with an optical waveguide (an optical waveguide to be coupled) having a refractive index distribution within a core in the vertical direction, wherein a cladding has a refractive index distribution in the vertical direction.

20. The optical waveguide for coupling as set forth in claim 19, wherein the refractive index distribution within the cladding is almost opposite to the refractive index distribution within the core of the optical waveguide to be coupled.

21. An optical waveguide (an optical waveguide for coupling) which is used for coupling with an optical waveguide (an optical waveguide to be coupled) having a refractive index distribution within a core in the vertical direction, wherein the relation between the relative magnitude of refractive indexes of the upper and lower cladding parts of the optical waveguide for coupling is completely opposite to the refractive index distribution in the vertical direction observed for the optical waveguide to be coupled.

22. The optical waveguide for coupling as set forth in claim 19, wherein the optical waveguide to be coupled is a diffusion optical waveguide.

23. The optical waveguide for coupling as set forth in claim 22, wherein the diffusion optical waveguide is an optical waveguide whose core is one formed by allowing titanium to diffuse in a lithium niobate substrate.

24. The method as set forth in claim 9, wherein the refractive index n1 of the material constituting the cladding on the upper side of the core, the refractive index n2 of the material constituting the cladding on the lateral side of the core and the refractive index n3 of the material constituting the cladding on the lower side of the core satisfy the following relation: n1≦nx×0.974 (provided that nx represents a smaller value selected from n2 and n3).

25. The method as set forth in claim 10, wherein each of the core material and the materials constituting the cladding on the lateral side of the core and the cladding on the lower side of the core is selected from the group consisting of polyimide resins, acrylic resins, epoxy resins, phenolic resins, silicone resins, and fluorocarbon resins.

26. The method as set forth in claim 9, wherein the material for forming the cladding on the upper side of the core is a member selected from the group consisting of air, SiO₂, acrylic resins, polyimide resins, epoxy resins, phenolic resins, silicone resins, and fluorocarbon resins.

27. The optical waveguide for coupling as set forth in claim 21, wherein the optical waveguide to be coupled is a diffusion optical waveguide.
